(19) United States
(12) Patent Application Publication
(10) Pub. No.: US 2015/0120557 A1
(43) Pub. Date: Apr. 30, 2015

(54) FINGERPRINT PAYMENT METHOD AND RELATED DEVICE AND SYSTEM

(71) Applicant: Tencent Technology (Shenzhen) Company Limited, Shenzhen (CN)

(72) Inventor: Yumiao ZHANG, Shenzhen (CN)

(21) Appl. No.: 14/484,015

(22) Filed: Sep. 11, 2014

Related U.S. Application Data
(63) Continuation of application No. PCT/CN2014/079340, filed on Jun. 6, 2014.

(30) Foreign Application Priority Data
Oct. 25, 2013 (CN) 201310513258.7

(51) Int. Cl. G06Q 20/40

(52) U.S. Cl. CPC G06Q 20/40145
USPC 705/44

(57) ABSTRACT

Method and device of processing a transaction are disclosed. The method includes: receiving a transaction request from a first transaction device, wherein the transaction request specifies a transaction account associated with a user and a transaction awaiting execution; in accordance with the received transaction request, identifying a second transaction device associated with the transaction account; acquiring first physiological biometric verification data from the first transaction device; acquiring second physiological biometric verification data from the second transaction device; verifying the acquired first and second physiological biometric verification data against stored physiological biometric information associated with the transaction account; and approving the requested transaction upon successful verification of the received first and second physiological biometric verification data.

### PRIORITY CLAIM AND RELATED APPLICATIONS

This application is a continuation application of PCT Patent Application No. PCT/CN2014/079340, entitled “A FINGERPRINT PAYMENT METHOD AND RELATED DEVICE AND SYSTEM” filed on Jun. 6, 2014, which claims priority to Chinese Patent Application No. 201310513258.7, entitled “A FINGERPRINT PAYMENT METHOD AND RELATED DEVICE AND SYSTEM,” filed on Oct. 25, 2013, both of which are incorporated by reference in their entirety.

### FIELD OF THE TECHNOLOGY

The present disclosure relates to the field of Internet technologies, and particularly to a biometric verification transaction and related devices and systems.

### BACKGROUND OF THE TECHNOLOGY

With rapid development of Internet technologies, using smart phones (such as Android phones and iOS phones), tablet computers, handheld computers as well as Mobile Internet Devices (MIDs), PADs and other user terminals for online payment has become a convenient and popular payment manner. However, in actual applications, when a user uses a user terminal for online payment, the user usually needs to manually input a payment password to complete the online payment. In practice, it is found that such a payment manner requires the user to manually enter the payment password, making the payment operation complicated, thereby reducing the efficiency of online payment. Moreover, manually inputting the payment password may lead to leakage of the payment password, which reduces payment security.

In addition, people increasingly rely on smart phones and portable electronics to perform various transactions, including payments. The traditional knowledge based security system is cumbersome to use, while the traditional biometric data based system is often not safe or accurate enough. Therefore, it is desirable to have a safe and fast transaction method.

### SUMMARY

In some embodiments, a method of processing a transaction is performed at a device having one or more processors and memory storing instructions for execution by the one or more processors. The method includes: receiving a transaction request from a first transaction device, wherein the transaction request specifies a transaction account associated with a user and a transaction awaiting execution; in accordance with the received transaction request, identifying a second transaction device associated with the transaction account; acquiring first physiological biometric verification data from the first transaction device; acquiring second physiological biometric verification data from the second transaction device; verifying the acquired first and second physiological biometric verification data against stored physiological biometric information associated with the transaction account; and approving the requested transaction upon successful verification of the received first and second physiological biometric verification data.

In another aspect, a device comprises one or more processors, memory, and one or more program modules stored in the memory and configured for execution by the one or more processors. The one or more program modules include instructions for performing the method described herein. In another aspect, a non-transitory computer readable storage medium having stored thereon instructions, which, when executed by a device, cause the device to perform the method described herein.

The embodiments described herein may provide at least the following advantages, for example, by requiring physiological biometric verification data from two different transaction devices associated with the transaction account, fraudulent or unauthorized transactions using a stolen password, stolen device, or fake biometric data may be effectively prevented. The correlation between the first and the second transaction devices in terms of location, required verification data can be used to further improve the security of the transaction verification method. The above advantages and additional advantages of the present technique are apparent in light of the descriptions below.

### BRIEF DESCRIPTION OF THE DRAWINGS

The aforementioned features and advantages as well as additional features and advantages will is more clearly understood hereinafter as a result of a detailed description of preferred embodiments when taken in conjunction with the drawings.

To illustrate the technical solutions according to the embodiments of the present disclosure more clearly, the accompanying drawings for describing the embodiments are introduced briefly in the following. Apparently, the accompanying drawings in the following description are merely some embodiments of the disclosed technology; persons skilled in the art obtain other drawings according to the accompanying drawings without paying any creative efforts.

FIG. 1 is a flowchart of a biometric verification transaction in accordance with some embodiments;

FIG. 2 is a schematic diagram of an interface in accordance with some embodiments;

FIG. 3 is a schematic diagram of a display interface in accordance with some embodiments;

FIG. 4 is a flowchart of a biometric verification transaction in accordance with some embodiments;

FIG. 5 is a flowchart of a biometric verification transaction in accordance with some embodiments;

FIG. 6 is a flowchart of a biometric verification transaction in accordance with some embodiments;

FIG. 7 is a structural diagram of a payment platform server in accordance with some embodiments;

FIG. 8 is a structural diagram of a payment platform server in accordance with some embodiments;

FIG. 9 is a structural diagram of a fingerprint payment system in accordance with some embodiments; and

FIG. 10 is a structural diagram of a transaction server in accordance with some embodiments.

Like reference numerals refer to corresponding parts throughout the several views of the drawings.

### DESCRIPTION OF EMBODIMENTS

Reference will now is made in detail to embodiments, examples of which are illustrated in the accompanying drawings. In the following detailed description, numerous specific details are set forth in order to provide a thorough understanding of the subject matter presented herein. But it will is apparent to one skilled in the art that the subject matter is practiced without these specific details. In other instances, well-known methods, procedures, components, and circuits have not been described in detail so as not to unnecessarily obscure aspects of the embodiments.

The technical solutions in the embodiments of the present technology are clearly and fully described below with reference to the accompanying drawings in the embodiments of the present technology. It is obvious that the embodiments described herein are only a part rather than all of the embodiments of the present technology. All other embodiments derived by persons skilled in the art based on the embodiments of the present technology without carrying out creative activities shall fall within the scope of the present technology.

The embodiments of the present technology disclose a biometric verification transaction and related devices and system, which can simplify the payment operation, improve the efficiency of online payment, and improve payment security. Detailed descriptions are given below respectively.

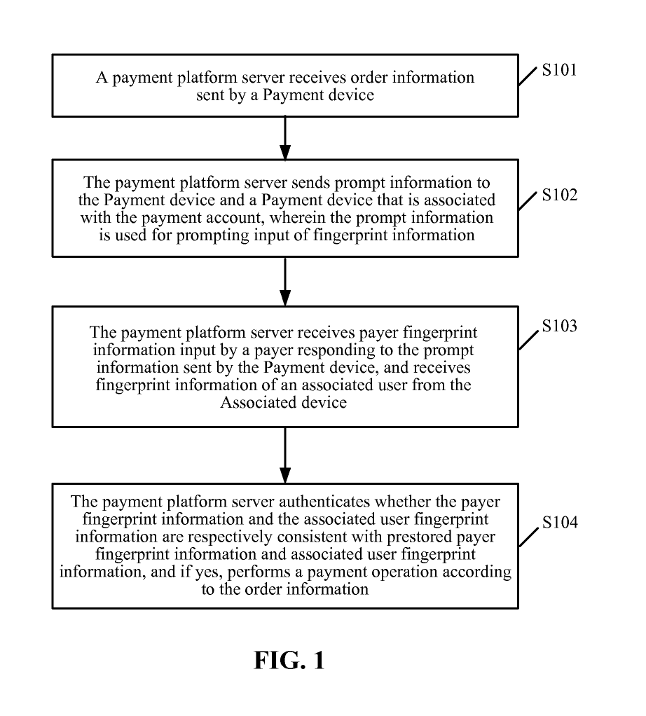

FIG. 1 is a flowchart of a biometric verification transaction in accordance with some embodiments. The biometric verification transaction described in FIG. 1 is mainly described from a payment platform server side. In addition, the transaction verification is described in the context of a payment transaction involving a payment device (e.g., serving as a first transaction device). As shown in FIG. 1, the biometric verification transaction includes the following steps.

In step S101, in accordance with some embodiments, a payment platform server receives order information sent by a payment device, wherein the order information includes a payment account and payment amount.

In accordance with some embodiments, the order information further includes an order number.

In accordance with some embodiments, a payment device is a smart phone (such as Android phones and iOS phones), a tablet computer, a handheld computer, a MID, a PAD, a POS machine and other user terminals. In some embodiments, the payment device is under the control of a payer of the payment transaction. For example, the payment device may be a POS terminal at a brick and mortar store. In some embodiments, the payment device is under the control of a payee of the payment transaction. For example, the payment device may be a smart phone or tablet computer that the user uses to perform an online purchase through an online store.

In step S102, in accordance with some embodiments, the payment platform server sends prompt information to the payment device and an associated device associated with the payment account (e.g., the associated device serves as a second transaction device), wherein the prompt information is used for prompting input of fingerprint information.

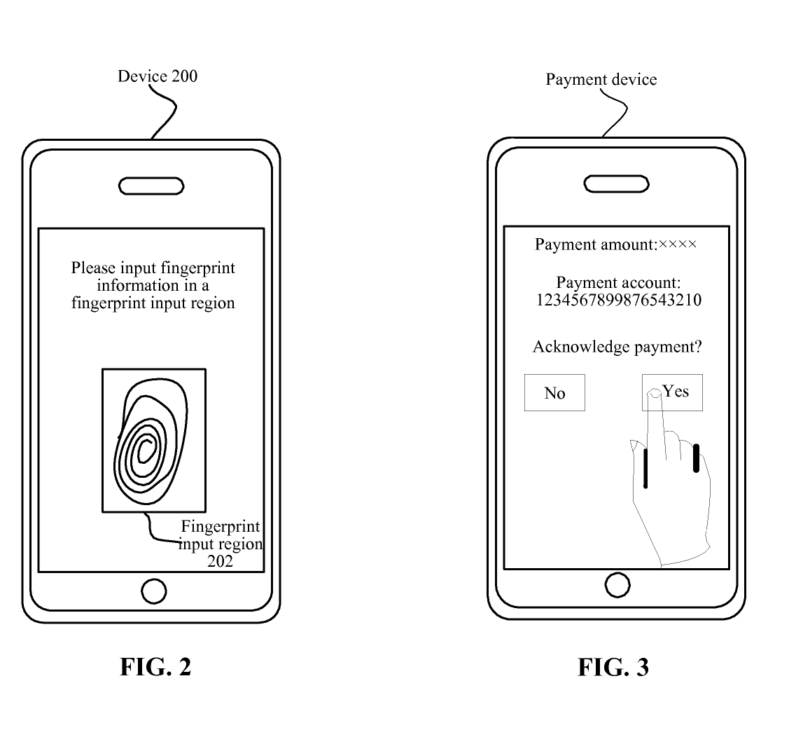

In accordance with some embodiments, the payment device prompt, after receiving the prompt information sent by the payment platform server, a payer to input fingerprint information. In some embodiments, as shown in FIG. 2, the payment device 200 prompts a payer to input fingerprint information in a fingerprint input region 202. In some embodiments, other physiological biometric information, such as voiceprint, retina scan data, etc. can also be used in conjunction or alternative to fingerprint information.

In accordance with some embodiments, the associated device prompt, after receiving the prompt information sent by the payment platform server, an associated user to input fingerprint information. In some embodiments, as shown in FIG. 2, the associated device prompt an associated user to input fingerprint information in a fingerprint input region.

In step S103, in accordance with some embodiments, the payment platform server receives payer fingerprint information responding to the prompt information sent by the payment device, and receives fingerprint information of an associated user responding to the prompt information sent by the associated device.

In step S104, in accordance with some embodiments, the payment platform server authenticates whether the payer fingerprint information and the associated user fingerprint information are respectively consistent with pre-stored payer fingerprint information and associated user fingerprint information, and if yes, performs a payment operation according to the order information. In some embodiments, different types of physiological biometric information may be requested from the first and the second transaction devices, and verified against different physiological biometric information stored in association with the transaction account (e.g., payment account).

In accordance with some embodiments, the payment platform server performing a payment operation specifically includes: deducting the payment amount included in the order information from the payment account, and paying the payment amount to a corresponding receiving account. The receiving account is associated with the payment platform server. Alternatively, the receiving account is associated with a transaction platform server when the payer places an order.

As an optional implementation manner, in the method described in FIG. 1, the payment platform server also executes the following steps before step S101.

11). The payment platform server receives a registration request sent by the payment device, wherein the registration request includes associated device identifier associated with the payment account.

In accordance with some embodiments, the associated device identifier is an SIM card number, a UIM card number, or an International Mobile Equipment Identification Number (IMEI) of the associated device.

12). The payment platform server responds to the registration request, sends a notification message to the payment device and the associated device according to the associated device identifier, wherein the notification message is used for prompting input of the fingerprint information.

13). The payment platform server stores the payer fingerprint information sent by the payment device, and stores the associated user fingerprint information sent by the associated device.

In accordance with some embodiments, the payment platform server stores a corresponding relationship between payment device identifiers and the payer fingerprint information as well as the associated user fingerprint information.

14). The payment platform server sends a registration complete response to the payment device, and sends an associated user fingerprint information storage complete message to the associated device.

Registration of the payment device and the associated device on the payment platform server is completed through step 11) to step 14), and storing the payer fingerprint information and the associated user fingerprint information is achieved in the payment platform server during the registration.

As an optional implementation manner, in the method described in FIG. 1, after the payment platform server authenticates that the payer fingerprint information and the associated user fingerprint information are respectively consistent with pre-stored payer fingerprint information and associated user fingerprint information, and before the payment operation is performed according to the order information, the following steps are executed.

21). The payment platform server sends an order information acknowledgment request to the payment device, wherein the order information acknowledgment request includes the payment account and the payment amount.

22). The payment platform server performs the payment operation according to the order information.

Payment security is improved through step 21) to step 22). In accordance with some embodiments, as shown in FIG. 3, the payment device displays the order information acknowledgment request sent by the transaction platform server, wherein the order information acknowledgment request includes payment amount “XXXX” and a payment account “1234567899876543210”. The payer clicks the “Yes” option in the interface shown in FIG. 3, and thus input an acknowledgment response for the order information acknowledgment request to the payment device. The payment device sends the acknowledgment response for the order information acknowledgment request to the transaction platform server.

As an optional implementation manner, in the method described in FIG. 1, the transaction platform server receives the order information sent by the payment device by means of the transaction platform server. Such a manner allows the payer to perform fingerprint payment in the process of placing an order. In accordance with some embodiments, the payment device also directly sends the order information to the payment platform server. This method allows fingerprint payment in the process of point-to-point payment (e.g., payment by swiping a mobile phone).

Further, in accordance with some embodiments, the method described in FIG. 1 also includes the following steps.

31). The payment platform server receives a discount rate corresponding to an amount range of historical payments.

32). The payment platform server performs a payment discount operation according to the order information and the discount rate. The payment discount operation is implemented through step 31) to step 32), so that it is favorable for stimulating transaction consumption. The method described in FIG. 1 performs multi-terminal multi-fingerprint security authentication according to the payer fingerprint information and the associated user fingerprint information, so that payment security is improved; besides, the method described in FIG. 1 eliminates cumbersome operations brought about by the user's manually inputting the payment password, which thereby simplify the payment operation and improve the payment efficiency.

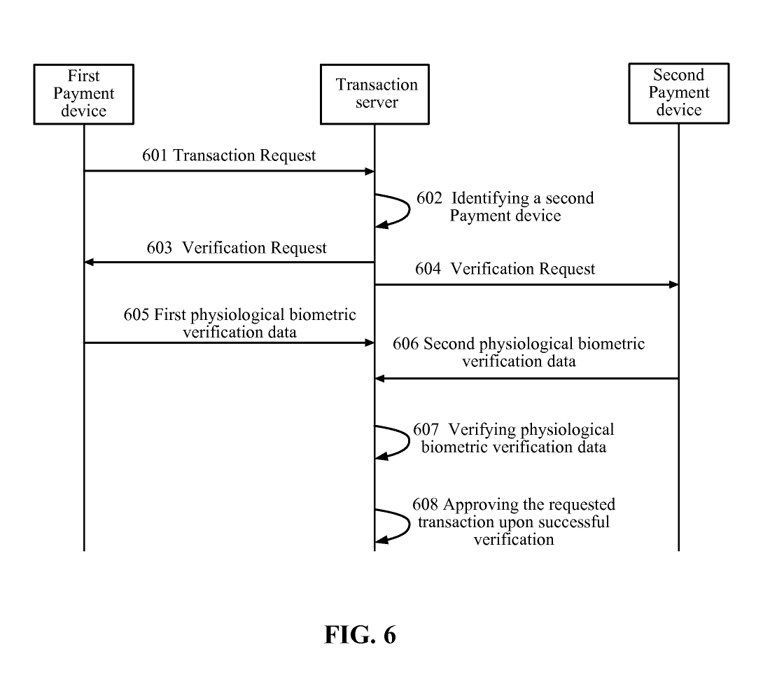

In some embodiments, the payer and the associated user is the same person. In some embodiments, the payment device and the associated device both belong to the same person or entity. In some embodiments, the payment device belongs to the payee and the associated device belongs to the payer of the payment. In some embodiments, the payment device is the first transaction device illustrated in FIG. 6 and is configured to perform instructions described in FIG. 6 and accompanying text. In some embodiments, the associated device is the second transaction device illustrated in FIG. 6 and is configured to perform instructions described in FIG. 6 and accompanying text. In some embodiments, the payment platform server is the transaction server illustrated in FIG. 6 and is configured to perform instructions described in FIG. 6 and accompanying text.

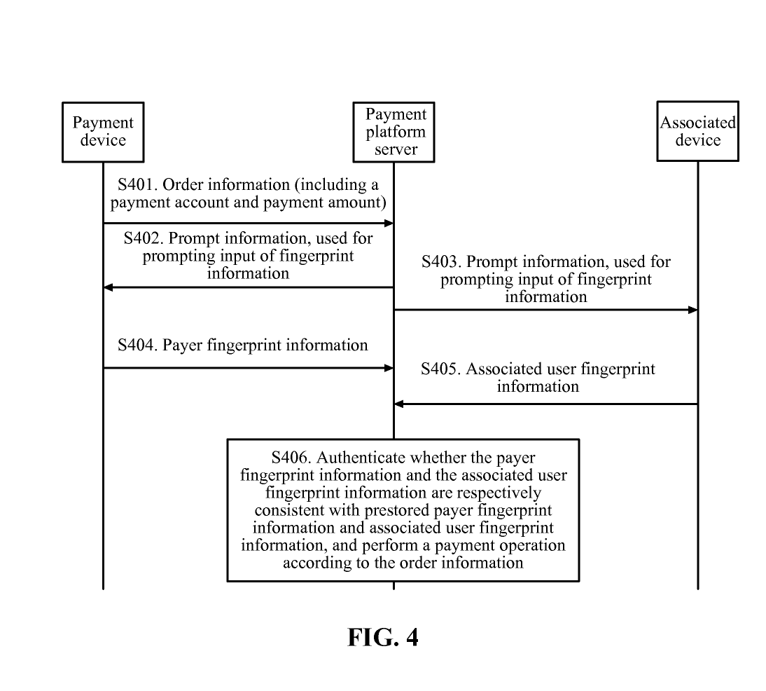

FIG. 4 is a flowchart of a biometric verification transaction in accordance with some embodiments. The biometric verification transaction described in FIG. 4 is mainly described from three aspects, i.e., a payment device, an associated device associated with a payment account and a payment platform server. As shown in FIG. 4, the biometric verification transaction includes the following steps.

In step S401, in accordance with some embodiments, a payment device sends order information to a payment platform server, wherein the order information includes a payment account and payment amount.

In step S402, in accordance with some embodiments, the payment platform server receives the order information sent by the payment device, and sends prompt information to the payment device, wherein the prompt information is used for prompting input of fingerprint information.

In step S403, in accordance with some embodiments, the payment platform server receives the order information sent by the payment device, and sends prompt information to an associated device associated with the payment account, wherein the prompt information is used for prompting input of fingerprint information.

In accordance with some embodiments, the execution order of step S402 and step S403 is reversed, or is executed at the same time.

In step S404, in accordance with some embodiments, the payment device receives the prompt information sent by the payment platform server, and sends payer fingerprint information responding to the prompt information to the payment platform server.

In step S405, in accordance with some embodiments, the associated device receives the prompt information sent by the payment platform server, and sends fingerprint information of an associated user responding to the prompt information to the payment platform server.

In accordance with some embodiments, the execution order of step S404 and step S405 is reversed, or is executed at the same time.

In step S406, in accordance with some embodiments, the payment platform server receives the payer fingerprint information sent by the payment device, receives the associated user fingerprint information sent by the associated device, authenticates whether the payer fingerprint information and the associated user fingerprint information are respectively consistent with pre-stored payer fingerprint information and associated user fingerprint information, and if yes, performs a payment operation according to the order information.

In accordance with some embodiments, if either the payer fingerprint information or the associated user fingerprint information is inconsistent with the pre-stored payer fingerprint information and associated user fingerprint information, the payment platform server ignore the order information, and does not perform the payment operation.

In accordance with some embodiments, the payment platform server deducts the payment amount included in the order information from the payment account, and pay the payment amount to a receiving account associated with the payment platform server (e.g., payment by swiping a mobile phone) or the transaction platform server (e.g., payment by placing an order).

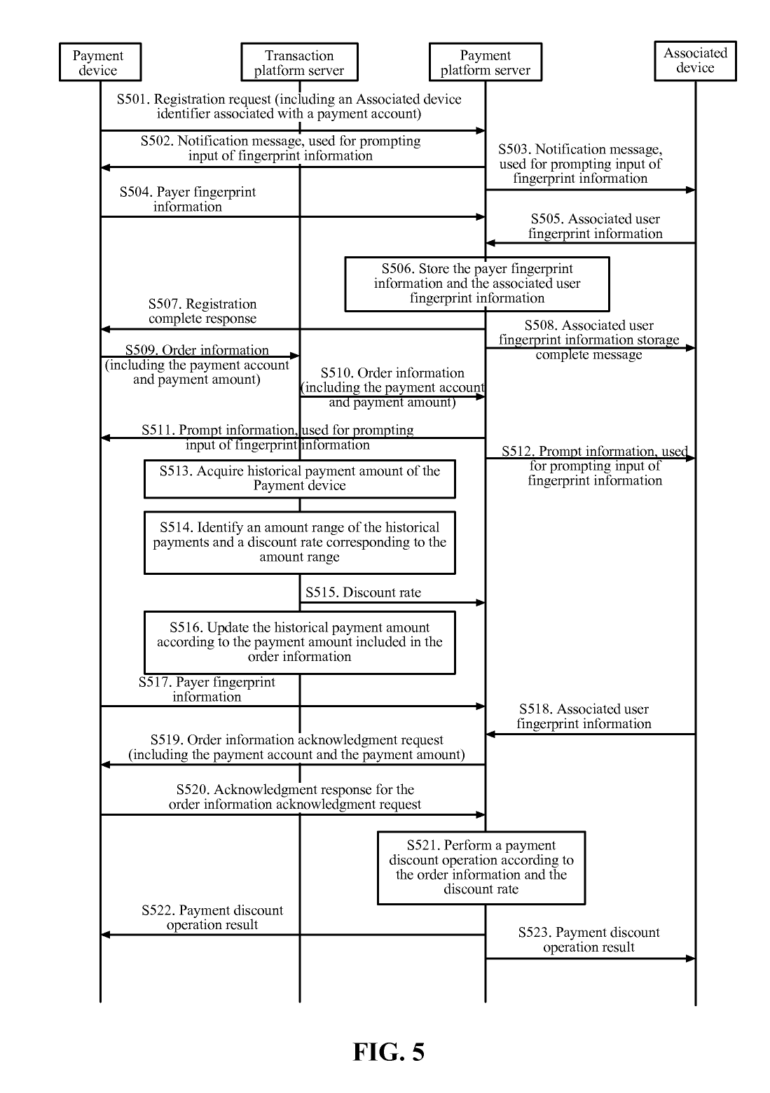

FIG. 5 is a flowchart of a biometric verification transaction in accordance with some embodiments. The biometric verification transaction described in FIG. 5 is mainly described from four aspects, i.e., a payment device, an associated device, a transaction platform server and a transaction platform server. As shown in FIG. 5, the biometric verification transaction includes the following steps.

In step S501, in accordance with some embodiments, a payment device sends a registration request to a payment platform server, wherein the registration request includes an associated device identifier associated with a payment account.

In step S502, in accordance with some embodiments, the payment platform server responds to the registration request, and sends a notification message to the payment device, wherein the notification message is used for prompting input of fingerprint information.

In step S503, in accordance with some embodiments, the payment platform server responds to the registration request, and sends the notification message to an associated device according to the associated device identifier, wherein the notification message is used for prompting input of fingerprint information.

In accordance with some embodiments, the execution order of step S502 and step S03 is reversed, or is executed at the same time.

In step S504, in accordance with some embodiments, the payment device receives the notification message sent by the payment platform server, and sends payer fingerprint information to the payment platform server.

In step S505, in accordance with some embodiments, the associated device receives the notification message sent by the payment platform server, and sends fingerprint information of an associated user to the payment platform server.

In accordance with some embodiments, the execution order of step S504 and step 505 is reversed, or is executed at the same time.

In step S506, in accordance with some embodiments, the payment platform server stores the payer fingerprint information and the associated user fingerprint information.

In step S507, in accordance with some embodiments, the payment platform server sends a registration complete response to the payment device.

In step S508, in accordance with some embodiments, the payment platform server sends an associated user fingerprint information storage complete message to the associated device.

In accordance with some embodiments, the execution order of step S507 and step 508 is reversed, or is executed at the same time.

In step S509, in accordance with some embodiments, the payment device sends order information to a transaction platform server, wherein the order information includes the payment account and payment amount.

In accordance with some embodiments, the execution order of step S508 and step 509 is reversed, or is executed at the same time.

In step S510, in accordance with some embodiments, the transaction platform server sends the order information to the payment platform server. In accordance with some embodiments, the order information includes payment device identifier, e.g., an SIM card number, a UIM card number, or IMEI of the payment device in addition to an order number.

In step S511, in accordance with some embodiments, the payment platform server receives the order information sent by the transaction platform server, and sends prompt information to the payment device, wherein the prompt information is used for prompting input of fingerprint information.

In accordance with some embodiments, the payment platform server sends the prompt information to the payment device according to the payment device identifier.

In step S512, in accordance with some embodiments, the transaction platform server receives the order information sent by the transaction platform server, and sends prompt information to the associated device associated with the payment account, wherein the prompt information is used for prompting input of fingerprint information.

In accordance with some embodiments, the execution order of step S511 and step 512 is reversed, or is executed at the same time.

In step S513, in accordance with some embodiments, the transaction platform server acquires historical payment amount of the payment device.

In step S514, in accordance with some embodiments, the transaction platform server identifies an amount range of the historical payments, and identifies a discount rate corresponding to the amount range.

In step S515, in accordance with some embodiments, the transaction platform server sends the discount rate to the payment platform server.

In step S516, in accordance with some embodiments, the transaction platform server updates the historical payment amount according to the payment amount included in the order information.

In accordance with some embodiments, the transaction platform server accumulate the payment amount included in the order information and the historical payment amount, and an accumulated value serves as new historical payment amount.

In step S517, in accordance with some embodiments, the payment device receives the prompt information sent by the transaction platform server, and sends the payer fingerprint information input by the payer responding to the prompt information to the payment platform server.

In step S518, in accordance with some embodiments, the associated device receives the prompt information sent by the payment platform server, and sends the fingerprint information of the associated user responding to the prompt information to the transaction platform server.

In accordance with some embodiments, the execution order of step S517 and step 518 is reversed, or is executed at the same time.

In step S519, in accordance with some embodiments, the payment platform server authenticates whether the payer fingerprint information and the associated user fingerprint information are respectively consistent with pre-stored payer fingerprint information and associated user fingerprint information, and if yes, sends an order information acknowledgment request to the payment device, wherein the order information acknowledgment request includes the payment account and the payment amount.

In step S520, in accordance with some embodiments, the payment device receives the order information acknowledgment request sent by the payment platform server, and sends an acknowledgment response for the order information acknowledgment request input by the payer to the payment platform server.

In step S521, in accordance with some embodiments, the payment platform server performs a payment discount operation according to the order information and the discount rate after receiving the acknowledgment response for the order information acknowledgment request sent by the payment device.

In accordance with some embodiments, the payment platform server deducts the payment amount included in the order information from the payment account, and pay the payment amount to a receiving account associated with the transaction account (e.g., payment by placing an order), wherein the transaction platform server previously register the receiving account in the payment platform server.

In step S522, in accordance with some embodiments, the payment platform server sends a payment discount operation result to the payment device.

In step S523, in accordance with some embodiments, the payment platform server sends the payment discount operation result to the associated device.

In accordance with some embodiments, it is feasible that steps S513-S514 is after step S510 and before step S521. The method described in FIG. 5 perform multi-terminal multi-fingerprint security authentication according to the payer fingerprint information and the associated user fingerprint information, so that payment security is improved.

FIG. 6 is a flowchart of processing a transaction in accordance with some embodiments. The method is performed at a server having one or more processors and memory storing instructions for execution by the one or more processors.

In some embodiments, the server is a transaction server. In some embodiments, the transaction server can be a payment platform server, a transaction platform server, or a combination of both, as illustrated in FIGS. 1-5.

In step 601, in accordance with some embodiments, the transaction server receives a transaction request from a first transaction device, wherein the transaction request specifies a transaction account associated with a user and a transaction awaiting execution.

In some embodiments, the transaction request includes a request for payment. In some embodiments, the transaction request includes a request for making certain financial arrangement, including performing certain security transaction, e.g., selling stocks. In some embodiments, the transaction request includes a management of an account, including changing personal information, transferring funds among accounts, changing password and other security settings. In some embodiments, the transaction request includes order information described in accompanying text of FIGS. 1-5.

In some embodiments, the first transaction device belongs to a merchant. For example, the first transaction device is a POS terminal of a merchant. For another example, the first transaction device is a ticket machine that belongs to a theatre, a sport center, or a train station. Customers can buy tickets through the ticket machine. In some embodiments, the first transaction device is the payment device illustrated in other figures.

In some embodiments, in the transaction request, the merchant is specified as a payee and the user associated with the transaction account is specified as a payer of the trans action.

In some embodiments, the first transaction device is a registered user device associated with the transaction account. For example, the first transaction device is a smart phone and is registered with a bank account of the owner of the smart phone. The bank maintains the transaction server, which records either a machine number or a phone number of the smart phone. The user uses the smart phone to scan a code in a taxi, which generates a transaction request to pay for a taxi drive.

In step 602, in accordance with some embodiments, the transaction server, in accordance with the received transaction request, identifies a second transaction device associated with the transaction account.

In some embodiments, the second transaction device is a registered user device associated with the transaction account. For example, the second transaction device is a mobile phone having a mobile phone number that is associated with the transaction account.

In some embodiments, the second transaction device is associated with a device identifier. In accordance with some embodiments, the device identifier is a SIM card number, a UIM card number, or an IMEI of the device. In some embodiments, the device identifier of a transaction device is stored in the transaction server and associated with a transaction account. In some embodiment, the user of the first transaction device selects the second transaction device and the device identifier of the second transaction device is included in the transaction request.

In step 603, in accordance with some embodiments, the transaction server sends a verification request to the first transaction device for collecting the first biometric verification data from the user.

In some embodiments, when the first transaction device has been set up to collect the first biometric verification data, the verification request is no more than a response confirming receiving the transaction request or the successful set-up of a link between the first transaction device and the transaction server. The first transaction device is programmed to begin collecting biometric verification data once receiving the confirmation response from the transaction server.

In some embodiments, the verification request includes detailed instructions on how or what biometric verification information should be collected.

In some embodiments, biometric verification data includes quantifiable data related to human characteristics and traits that can be used for identification of a user. Biometric verification data includes fingerprint, iris scan, palm print, voice data, facial image, etc.

In step 604, in accordance with some embodiments, the transaction server sends a verification request to the second transaction device for collecting the second biometric verification data from the user.

In step 605, in accordance with some embodiments, the transaction server acquires first physiological biometric verification data from the first transaction device.

In step 606, in accordance with some embodiments, the transaction server acquires first physiological biometric verification data from the first transaction device.

In some embodiments, the payment request includes the first physiological biometric verification data so that the receiving the transaction request and acquiring the first physiological biometric verification data is completed simultaneously.

In accordance with some embodiments, identifying the second transaction device and acquiring the second physiological biometric verification data are performed after successful verification of the first physiological biometric verification data.

In accordance with some embodiments, the first and second physiological biometric verification data include fingerprint data.

In step 607, in accordance with some embodiments, the transaction server verifies the acquired first and second physiological biometric verification data against stored physiological biometric information associated with the transaction account.

In some embodiments, acquiring the first physiological biometric verification data from the first transaction device further comprises: sending a verification request to the first transaction device, the verification request specifying a requirement for the first physiological biometric verification data to be collected from the first transaction device. In some embodiments, verifying the received first physiological biometric verification data comprises: verifying the received first physiological biometric verification data in accordance with the requirement specified in the verification request. For example, the transaction server determines that it has stored 15 sets of physiological biometric verification data, one set is collected from the fingerprint of the index finger of the right hand of the holder of the transaction account. A verification request may specify that the finger print of the index finger of the right hand needs to be collected for the first physiological biometric verification data.

In some embodiments, acquiring the first physiological biometric verification data from the first transaction device further comprises: providing a listing of acceptable verification data types to the first transaction device; and receiving a user selection from the listing of acceptable verification data types from the first transaction device. The listing can be based on the stored biometric verification data in the transaction server for a particular transaction account. The listing can be also based on the capacities of the first transaction device. In some embodiments, verifying the received first physiological biometric verification data comprises: verifying the received first physiological biometric verification data in accordance with the user selection received from the first transaction device. For example, the first transaction device receives a listing of acceptable verification data types from the transaction server, and displays the list. A user of the first transaction device can select one of them. The transaction server receives the selection and determines which stored verification data is used to be compared with the received verification data in accordance with the selection.

In some embodiments, acquiring the second physiological biometric verification data from the second transaction device further comprises: sending a verification request to the second transaction device, the verification request specifying a requirement for the second physiological biometric verification data to be collected from the second transaction device. In some embodiments, verifying the received second physiological biometric verification data comprises: verifying the received second physiological biometric verification data in accordance with the requirement specified in the verification request. For example, the transaction server determines that it has stored 15 sets of physiological biometric verification data, one set is collected by taking a photo of the face of the holder of the transaction account. A verification request may specify that the user of the second transaction device needs to take a photo of his/her face for the second physiological biometric verification data.

In some embodiments, acquiring the second physiological biometric verification data from the second transaction device further comprises: providing a listing of acceptable verification data types to the second transaction device; and receiving a user selection from the listing of acceptable verification data types from the second transaction device. The listing can be based on the stored biometric verification data in the transaction server for a particular transaction account. The listing can be also based on the capacities of the second transaction device. In some embodiments, verifying the received second physiological biometric verification data comprises: verifying the received second physiological biometric verification data in accordance with the user selection received from the second transaction device. For example, the second transaction device receives a listing of acceptable verification data types from the transaction server, and displays the list. A user of the second transaction device can select one of them. The transaction server receives the selection and determines which stored verification data is used to be compared with the received verification data in accordance with the selection.

In some embodiments, the verification request specifies a combination of physiological biometric verification data. For example, the transaction server requires a transaction device to collect the face image and the voice data of the user.

In some embodiments, the transaction server randomly selects the type of biometric verification data to be collected from a particular transaction device. In some embodiments, a particular transaction device has certain limitation on what type of data can be selected, which limitation is stored in the transaction server. For example, a transaction device can be too small to read palm print. Also, the transaction server can only selects from types (and sub-types) of biometric verification data that the server has stored the relevant biometric verification data.

In some embodiments, the transaction request received from the first transaction device further includes a user selection of the type of biometric information required from the second transaction device. In some embodiments, acquiring the second physiological biometric verification data from the second transaction device further comprises: sending a verification request to the second transaction device, the verification request includes the user selection that has been received in the transaction request. In some embodiments, verifying the received second physiological biometric verification data further comprises: verifying the received second physiological biometric verification data in accordance with the user selection specified in the transaction request. For example, a user of the first transaction device specifies that the second transaction device needs to collect the finger print of thumb of the left hand of the user. Such selection is included in the transaction request and sent to the transaction server. When collecting the finger print, the second transaction device does not remind the user which finger is to be used so as to enhance security. The stored data of the finger print of thumb of the left hand of the user is used to be compared with the received data. For another example, the user is in a noisy environment, which is not ideal for voice recognition. The user specifies that he/she wants to use palm print as the second biometric verification data. The selection is included in the transaction request and sent to the transaction server.

In step 608, in accordance with some embodiments, the transaction server approves the requested transaction upon successful verification of the received first and second physiological biometric verification data. In some embodiments, after approving the requested transaction, the transaction server executes the requested transaction. In some embodiments, the transaction server notifies other devices and/or organizations the approval and other devices and/or organizations execute the requested transaction.

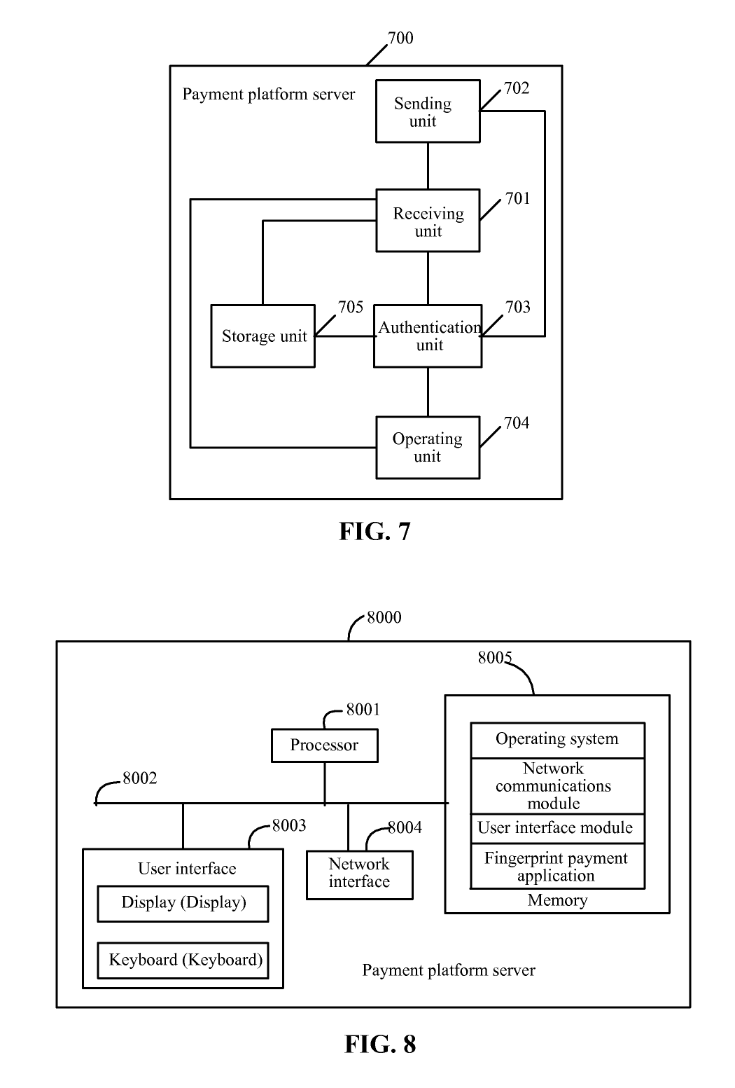

FIG. 7 is a structural diagram of a transaction platform server in accordance with some embodiments. As shown in FIG. 7, the payment platform server 700 includes:

a receiving unit 701, used for receiving order information sent by a payment device, wherein the order information includes a payment account and payment amount;

a sending unit 702, used for sending prompt information to the payment device and an associated device associated with the payment account, receiving payer fingerprint information, and receiving fingerprint information of an associated user;

an authentication unit 703, used for authenticating whether the payer fingerprint information and the associated user fingerprint information are respectively consistent with pre-stored payer fingerprint information and associated user fingerprint information; and

an operating unit 704, used for performing a payment operation and receiving a registration request.

In accordance with some embodiments, the sending unit 702 is further used for responding to the registration request, sending a notification message to the payment device, and sending the notification message to the associated device.

In accordance with some embodiments, the payment platform server 700 further includes: a storage unit 705, used for storing the payer fingerprint information sent by the payment device and the associated user fingerprint information sent by the associated device. The sending unit 702 is further used for sending a registration complete response to the payment device, and sending an associated user fingerprint information storage complete message to the associated device. In accordance with some embodiments, the authentication unit 703 is specifically used for authenticating whether the payer fingerprint information and the associated user fingerprint information are respectively consistent with payer fingerprint information and associated user fingerprint information pre-stored by the storage unit 705.

In some embodiments, the sending unit 702 is further used for sending an order information acknowledgment request to the payment device.

In some embodiments, the receiving unit 701 is further used for triggering the operating unit 704 to execute the step of performing the payment operation according to the order information.

In some embodiments, the receiving unit 701 receives the order information sent by the payment device and a discount rate.

In some embodiments, the operating unit 704 is further used for performing a payment discount operation according to the order information and the discount rate.

In accordance with some embodiments, the transaction platform server deducts the payment amount included in the order information from the payment account, and pays the payment amount to a receiving account.

FIG. 8 is a structural diagram of a payment platform server in accordance with some embodiments. As shown in FIG. 8, the payment platform server 8000 includes: at least one processor 8001, such as, a CPU, at least one network interface 8004, a user interface 8003, a memory 8005 and at least one communication bus 8002. The communication bus 8002 is used for implementing connections and communications between the components. The user interface 8003 includes a Display and a Keyboard, and optionally, the user interface 8003 also includes standard wired interfaces and wireless interfaces. The network interface 8004 optionally includes standard wired interfaces and wireless interfaces (such as, WI-FI interfaces). The memory 8005 is a high-speed RAM memory, or a non-volatile memory, e.g., a magnetic disk memory. Optionally, the memory 8005 also is at least one storage device located away from the processor 8001. As shown in FIG. 8, the memory 8005, as a computer storage medium, includes an operating system, a network communications module, a user interface module and a fingerprint payment program.

In the payment platform server 8000 shown in FIG. 8, the network interface 8004 is mainly used for connecting a payment device and an associated device, and conducting data communication with the payment device and the associated device. The processor 8001 is used for calling the fingerprint payment program stored in the memory 8005, and executing the following operations:

Receiving, through the network interface 8004, order information sent by the payment device, prompt information to the payment device and the associated device associated with the payment account;

Receiving, through the network interface 8004, payer fingerprint information and fingerprint information of an associated user; and

Authenticating whether the payer fingerprint information and the associated user fingerprint information are respectively consistent with pre-stored payer fingerprint information and associated user fingerprint information, and if yes, performing a payment operation according to the order information.

In accordance with some embodiments, the memory 8005 pre-stores the payer fingerprint information and the associated user fingerprint information.

In some embodiments, the processor 8001 calls the fingerprint payment program stored in the memory 8005, and also execute the following operations:

Receiving, through the network interface 8004, a registration request sent by the payment device;

Responding to the registration request, sending a notification message to the payment device and a notification message to the associated device according to the associated device identifier through the network interface 8004;

In the memory 8005, storing the payer fingerprint and the associated user fingerprint information; and

Sending a registration complete response to the payment device through the network interface 8004, and sending an associated user fingerprint information storage complete message to the associated device.

In some embodiments, the processor 8001 calls the fingerprint payment program stored in the memory 8005, and also execute the following operations:

Sending an order information acknowledgment request to the payment device through the network interface 8004; and

After receiving an acknowledgment response for the order information acknowledgment request, executing the step of performing a payment operation according to the order information.

In some embodiments, the manner in which the network interface 8004 receives the order information order information sent by the payment device through a transaction platform server.

In some embodiments, the processor 8001 calls the fingerprint payment program stored in the memory 8005, and executes the following operations: receiving a discount rate corresponding to an amount range to which historical payment amount of the payment device; and performing a payment discount operation according to the order information and the discount rate.

In some embodiments, the processor 8001 calls the fingerprint payment program stored in the memory 8005, and also execute the step of sending a payment discount operation result to the payment device and the payment discount operation result to the associated device through the network interface 8004.

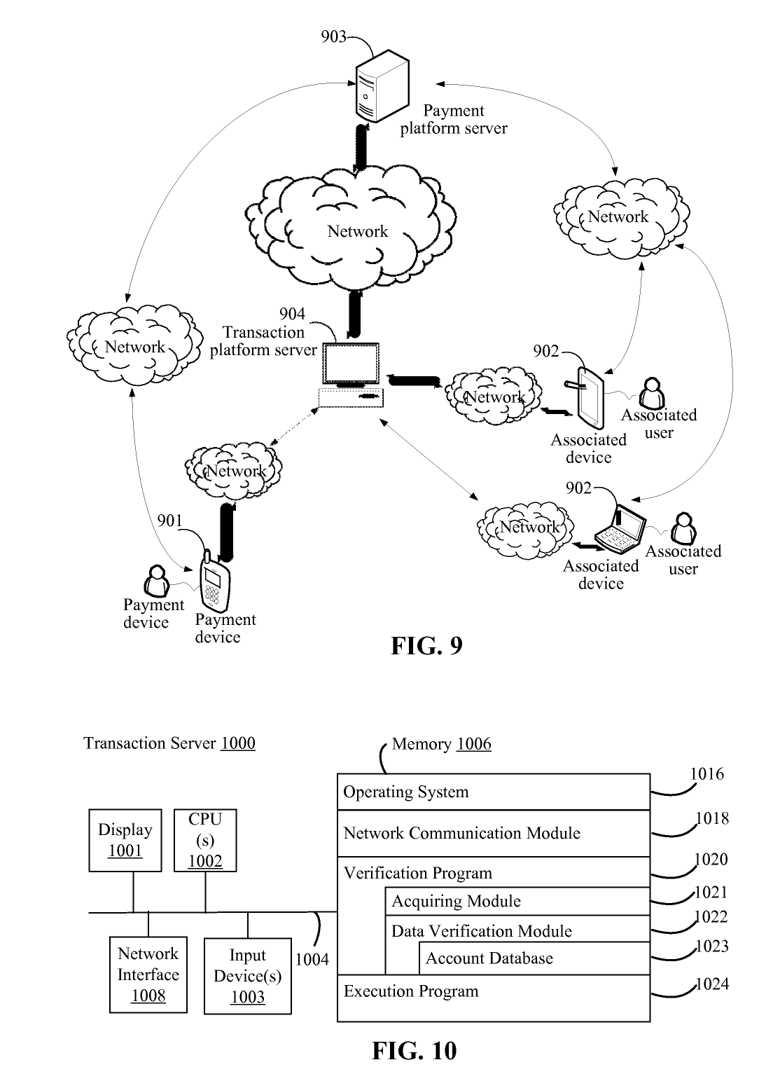

FIG. 9 is a structural diagram of a fingerprint payment system in accordance with some embodiments. As shown in FIG. 9, the fingerprint payment system includes a payment device 901, an associated device 902 associated with a payment account and a payment platform server 903.

In some embodiments, the payment device 901 is used for sending order information to the payment platform server 903.

In some embodiments, the payment platform server 903 is used for receiving the order information sent by the payment device 901, and sending prompt information to the payment device 901 and the associated device 902 associated with the payment account.

In some embodiments, the payment device 901 is further used for receiving the prompt information, and sending payer fingerprint information.

In some embodiments, the associated device 902 is used for receiving the prompt information, and sending fingerprint information of an associated user.

In some embodiments, the payment platform server 903 is further used for receiving the payer fingerprint information sent by the payment device 901, receiving the associated user fingerprint information sent by the associated device 902, authenticating whether the payer fingerprint information and the associated user fingerprint information are respectively consistent with pre-stored payer fingerprint information and associated user fingerprint information, and if yes, performing a payment operation according to the order information.

In some embodiments, in the system shown in FIG. 9, the payment device 901 is further used for sending a registration request to the payment platform server 903 before sending the order information to the payment platform server 903, and sending the notification message to the associated device 902 according to the identification of the associated device 902.

In some embodiments, the payment device 901 is further used for receiving the notification message sent by the payment platform server 903, and sending payer fingerprint information responding to the notification message to the payment platform server 903.

In some embodiments, the associated device 902 is further used for receiving the notification message sent by the payment platform server 903, and sending fingerprint information of an associated user.

In some embodiments, the payment platform server 903 is further used for storing the payer fingerprint information and the associated user fingerprint information; and

In some embodiments, the payment platform server 903 is further used for sending a registration complete response to the payment device 901, and sending an associated user fingerprint information storage complete message to the associated device 902.

In some embodiments, the payment platform server 903 is further used for sending an order information acknowledgment request to the payment device 901.

In some embodiments, the payment device 901 is further used for receiving the order information acknowledgment request sent by the payment platform server 903, and sending an acknowledgment response for the order information acknowledgment request input by the payer to the payment platform server 903.

In some embodiments, the payment platform server 903 is further used for executing the step of performing a payment operation according to the order information.

In some embodiments, the system shown in FIG. 9 further includes a transaction platform server 904, wherein the payment device 901 and the associated device 902 is connected to the transaction platform server 904 through a network, and the transaction platform server 904 is connected to the payment platform server 903 through the network.

In some embodiments, the payment device 901 is used for sending the order information to the transaction platform server 904;

In some embodiments, the transaction platform server 904 is used for sending the order information to the payment platform server 903.

In some embodiments, the transaction platform server 904 is further used for acquiring historical payment amount of the payment device 901, identifying an amount range of the historical payments, identifying a discount rate corresponding to the amount range, and sending the discount rate to the payment platform server 903.

In some embodiments, the payment platform server 903 is further used for performing a payment discount operation according to the order information and the discount rate after receiving the acknowledgment response for the order information acknowledgment request sent by the payment device 901.

In some embodiments, the transaction platform server 904 is further used for updating the historical payment amount according to the payment amount included in the order information after sending the discount rate to the payment platform server 903.

FIG. 10 is a diagram of an example implementation of a transaction server 1000 in accordance with some embodiments. While certain specific features are illustrated, those skilled in the art will appreciate from the present disclosure that various other features have not been illustrated for the sake of brevity and so as not to obscure more pertinent aspects of the implementations disclosed herein. To that end, the transaction server 1000 includes one or more processing units (CPU's) 1002, one or more network or other communications interfaces 1008, a display 1001, memory 1006, and one or more communication buses 1004 for interconnecting these and various other components. The communication buses may include circuitry (sometimes called a chipset) that interconnects and controls communications between system components. The memory 1006 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 1006 may optionally include one or more storage devices remotely located from the CPU(s) 1002. The memory 1006, including the non-volatile and volatile memory device(s) within the memory 1006, comprises a non-transitory computer readable storage medium.

In some implementations, the memory 1006 or the non-transitory computer readable storage medium of the memory 1006 stores the following programs, modules and data structures, or a subset thereof including an operating system 1016, a network communication module 1018, a verification program 1020 and a execution program 1024.

In accordance with some embodiments, the operating system 1016 includes procedures for handling various basic system services and for performing hardware dependent tasks.

In accordance with some embodiments, the network communication module 1018 facilitates communication with other devices via the one or more communication network interfaces 1008 (wired or wireless) and one or more communication networks, such as the internet, other wide area networks, local area networks, metropolitan area networks, and so on.

In accordance with some embodiments, the verification program 1020 is configured to acquire, possibly through the network communication module 1018, biometric verification data from transaction devices and verify whether the acquired data is consistent with the data stored in the transaction server. The verification program 1020 includes acquiring module 1021 and data verification module 1022. The acquiring module is configured to acquire biometric verification information from transaction devices in accordance with steps 601-606 as illustrated in FIG. 6. The data verification module 1022 is configured to examine whether the data acquired from the acquiring module 1021 is consistent with the data stored in an account database 1023. The account database 1023 is included in the data verification module 1022 and, inter alia, is configured to store biometric verification data related with a particular user and/or account.

The execution program 1024 is configured to approve a transaction request and start the requested transaction.

While particular embodiments are described above, it will is understood it is not intended to limit the disclosure to these particular embodiments. On the contrary, the disclosed technology includes alternatives, modifications and equivalents that are within the spirit and scope of the appended claims. Numerous specific details are set forth in order to provide a thorough understanding of the subject matter presented herein. But it will is apparent to one of ordinary skill in the art that the subject matter is practiced without these specific details. In other instances, well-known methods, procedures, components, and circuits have not been described in detail so as not to unnecessarily obscure aspects of the embodiments.

What is claimed is:

1. A method of processing a transaction, comprising:
at a server having one or more processors and memory for storing one or more programs to be executed by the one or more processors:
receiving a transaction request from a first transaction device, wherein the transaction request specifies a transaction account associated with a user and a transaction awaiting execution;
in accordance with the received transaction request, identifying a second transaction device associated with the transaction account;
acquiring first physiological biometric verification data from the first transaction device;
acquiring second physiological biometric verification data from the second transaction device;
verifying the acquired first and second physiological biometric verification data against stored physiological biometric information associated with the transaction account; and
approving the requested transaction upon successful verification of the received first and second physiological biometric verification data.

2. The method of claim 1, wherein identifying the second transaction device and acquiring the second physiological biometric verification data are performed after successful verification of the first physiological biometric verification data.

3. The method of claim 1, further comprising:
sending a verification request to the second transaction device for collecting the second biometric verification data from the user.

4. The method of claim 1, wherein the first transaction device is a registered user device associated with the transaction account.

5. The method of claim 1, wherein the second transaction device is a mobile phone having a mobile phone number that is associated with the transaction account.

6. The method of claim 1, wherein:
acquiring the first physiological biometric verification data from the first transaction device further comprises:
sending a verification request to the first transaction device, the verification request specifying a requirement for the first physiological biometric verification data to be collected from the first transaction device; and
verifying the received first physiological biometric verification data comprises:
verifying the received first physiological biometric verification data in accordance with the requirement specified in the verification request.

7. The method of claim 6, wherein the requirement in the verification request includes a randomly generated selection from a plurality of pre-set types of biometric information.

8. The method of claim 1, wherein the transaction request received from the first transaction device further includes a user selection of the type of biometric information required from the second transaction device.

9. The method of claim 1, wherein acquiring the second physiological biometric verification data from the second transaction device further comprises:
sending a verification request to the second transaction device, the verification request includes the user selection that has been received in the transaction request.

10. The method of claim 1, wherein verifying the received second physiological biometric verification data further comprises:
verifying the received second physiological biometric verification data in accordance with the user selection specified in the transaction request.

11. The method of claim 1, wherein:
acquiring the first physiological biometric verification data from the first transaction device further comprises:
providing a listing of acceptable verification data types to the first transaction device; and
receiving a user selection from the listing of acceptable verification data types from the first transaction device; and
verifying the received first physiological biometric verification data comprises:
verifying the received first physiological biometric verification data in accordance with the user selection received from the first transaction device.

12. A server of processing a transaction, comprising:
one or more processors; and
memory storing one or more programs for execution by the one or more processors, the one or more programs including instructions for:
receiving a transaction request from a first transaction device, wherein the transaction request specifies a transaction account associated with a user and a transaction awaiting execution;
in accordance with the received transaction request, identifying a second transaction device associated with the transaction account;
acquiring first physiological biometric verification data from the first transaction device;
acquiring second physiological biometric verification data from the second transaction device;
verifying the acquired first and second physiological biometric verification data against stored physiological biometric information associated with the transaction account; and
approving the requested transaction upon successful verification of the received first and second physiological biometric verification data.

13. The server of claim 12, wherein the first transaction device is a POS terminal of a merchant.

14. The server of claim 13, wherein, in the transaction request, the merchant is specified as a payee and the user associated with the transaction account is specified as a payer of the trans action.

15. The server of claim 12, wherein the one or more program modules further include instructions for:
sending a verification request to the second transaction device for collecting the second biometric verification data from the user.

16. The server of claim 12, wherein the first transaction device is a registered user device associated with the transaction account.

17. The server of claim 12, wherein the second transaction device is a mobile phone having a mobile phone number that is associated with the transaction account.

18. The server of claim 12, wherein:
acquiring the second physiological biometric verification data from the second transaction device further comprises:
sending a verification request to the second transaction device, the verification request specifying a requirement for the second physiological biometric verification data to be collected from the second transaction device; and
verifying the received second physiological biometric verification data comprises:
verifying the received second physiological biometric verification data in accordance with the requirement specified in the verification request.

19. The server of claim 12, wherein the transaction request received from the first transaction device further includes a user selection of the type of biometric information required from the second transaction device.

20. A non-transitory computer readable storage medium having instructions stored thereon, the instructions, when executed by one or more processors, cause the processors to perform operations comprising:
receiving a transaction request from a first transaction device, wherein the transaction request specifies a transaction account associated with a user and a transaction awaiting execution;
in accordance with the received transaction request, identifying a second transaction device associated with the transaction account;
acquiring first physiological biometric verification data from the first transaction device;
acquiring second physiological biometric verification data from the second transaction device;
verifying the acquired first and second physiological biometric verification data against stored physiological biometric information associated with the transaction account; and
approving the requested transaction upon successful verification of the received first and second physiological biometric verification data.
